(19) United States
(12) Patent Application Publication
(10) Pub. No.: US 2025/0028283 A1
(43) Pub. Date: Jan. 23, 2025

(54) SYSTEM FOR ATTACHING A DISPLAY ELEMENT

(71) Applicant: ETA SA Manufacture Horlogère Suisse, Grenchen (CH)

(72) Inventors: Stefan Stark, Prêles (CH); Olivier Mahler, Fontaines (CH); Jérôme Grosjean, Pieterlen (CH); David Benjamin Kraehenbuehl, Bettlach (CH)

(73) Assignee: ETA SA Manufacture Horlogère Suisse, Grenchen (CH)

(21) Appl. No.: 18/761,916

(22) Filed: Jul. 2, 2024

(30) Foreign Application Priority Data
Jul. 18, 2023 (EP) 23186184.0

(51) Int. Cl. G04B 19/04

(52) U.S. Cl. CPC G04B 19/044

(57) ABSTRACT

A system (1) for attaching a display element (2) to a drive shaft (3) fitted to an analogue display mechanism of a measuring apparatus, the system (1) including a portion (6) for mounting the display element (2) made of a material that has the property of softening and an embeddable end piece (4a) of said drive shaft (3) configured to be incorporated into said portion (4a) by melting, said end piece (4a) including part of a peripheral wall (13) of the drive shaft (3) provided with a patterned outer bonding surface configured to mechanically anchor said end piece (4a) in said portion (6).

### CROSS REFERENCE TO RELATED APPLICATION

This application claims priority to European Patent Application No. 23186184.0 filed Jul. 18, 2023, the entire contents of which are incorporated herein by reference.

### TECHNICAL FIELD OF THE INVENTION

The invention relates to the field of measuring instruments, in particular in the watchmaking field, and more particularly to the field of systems for attaching a display element such as a display hand on a drive shaft of a display mechanism.

The invention further relates to a measuring instrument such as a timepiece comprising such a display element mounted on this drive shaft using this attachment system.

### TECHNOLOGICAL BACKGROUND

In the prior art, measuring instruments such as timepieces comprise watch hands that are attached to their drive shafts by means of a forcibly driven attachment system, i.e. a hollow cylinder, in this case the pipe, is forced onto an arbor with a diameter slightly greater than the internal diameter of the cylinder. In this system, the elastic and plastic properties of the materials used, which are typically a metal, are used for this driving operation. As a result, a hollow cylinder can only be driven onto a conventional rotary shaft, such as those used in mechanical watchmaking, with a difference in diameter of a few microns. Alternatively, this hollow cylinder, which is preferably a straight circular cylinder, can also be driven onto a frustoconical rotary shaft in order to limit the excessively high driving forces that could damage the movement during this operation.

Moreover, the attachment of a hand must provide sufficient force to hold the hand in place during impacts. The force required to drive in a conventional watch hand, for example, is of the order of 30 N.

To solve these problems, one solution is to make hands with a pipe having one or more slots parallel to the axis of rotation and open at the opposite end of the hand so that the pipe deforms elastically.

However, one major drawback of this solution is that the slots in the pipe weaken it, which means that the slots have to be extremely narrow in order not to weaken the pipe too much. It should also be noted that machining operations are complex in order to obtain the finest possible slots while respecting the width and length required to obtain the desired driving force, which increases production costs and time.

### SUMMARY OF THE INVENTION

The main aim of the invention is to overcome the various drawbacks of prior art.

Another aim of the invention is to provide an attachment system which improves the hold of a display element having a non-metallic body, and therefore insensitive to magnetic fields, on a drive shaft of a display mechanism of a measuring instrument.

Another aim of the invention is to provide an attachment system wherein the display element has a reduced mass and inertia, and in any desired shape.

Another aim of the invention is to provide an attachment system wherein the display element is robust over time and whose manufacturing cost is reduced.

In accordance therewith, one aspect of the invention relates to a system for attaching a display element to a drive shaft fitted to an analogue display mechanism of a measuring instrument, the system comprising a portion for mounting the display element made of a material that has the property of softening and an embeddable end piece of said drive shaft configured to be incorporated into said portion by melting, said end piece comprising part of a peripheral wall of the drive shaft provided with a patterned outer bonding surface configured to mechanically anchor said end piece in said portion.

In other embodiments:
the mounting portion comprises a pipe in which a shaft hole is made and configured to mount the display element to the drive shaft;
the embeddable end piece is incorporated into the pipe by melting;
the patterned outer surface comprises a plurality of raised patterns;
the plurality of raised patterns extends over all or part of the patterned outer surface;
the part of the peripheral wall of said end piece projects on either side respectively of the opposite faces of the mounting portion of said display element;
the material liable to soften comprises, in whole or in part, a plastic material having the property of softening;
said end piece comprises first and second parts projecting respectively from the two opposite openings of the shaft hole of the pipe;
said embeddable end piece is made of a material having a softening point that is higher than a softening point of the material constituting said mounting portion;
an area for assembling the mounting portion with said end piece, wherein the materials respectively constituting said end piece and said pipe are incorporated into one another by melting, integration or association, in particular by melting, integration or association using ultrasound;
said display element has a body that is symmetrical relative to a longitudinal plane of symmetry and/or a transverse plane of symmetry;
said display element is a display hand whose body comprises a plate provided with the assembly area.

Another aspect of the invention relates to a measuring instrument comprising at least one such display element mounted on an embeddable end piece of a drive shaft using such an attachment system.

Advantageously, such an instrument is a timepiece.

### BRIEF DESCRIPTION OF THE FIGURES

Other features and advantages of the invention will be better understood upon reading the following description given of a non-limiting specific embodiment of the invention, provided for illustration purposes with reference to the accompanying figures, in which:

FIG. 1 is a view of the system for attaching a display element for mounting this element on an embeddable end piece of a drive shaft fitted to a display mechanism of a measuring instrument, according to one embodiment of the invention;

FIG. 2 is a top view of the attachment system wherein the end piece of the shaft is incorporated into or integrated into or associated with a pipe of the display element, according to the embodiment of the invention; and

FIG. 3 is a longitudinal sectional view along line III-III of said mounting portion of the display element shown in FIG. 2, according to the embodiment of the invention.

### DETAILED DESCRIPTION OF THE INVENTION

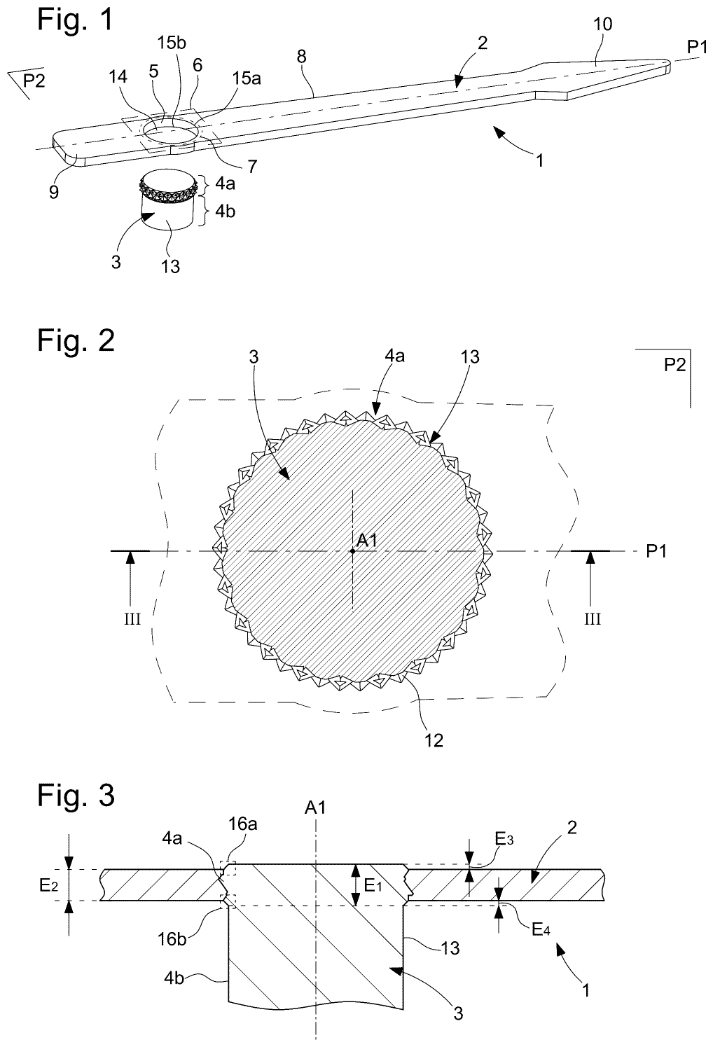

With reference to FIGS. 1 to 3, the invention relates to a system 1 for attaching a display element 2 to a drive shaft 3 of an analogue display mechanism of a mechanical, electronic or hybrid measuring instrument. This device can, in a non-limitative and non-exhaustive manner, help to measure the speed of movement of an object by being a tachometer, or atmospheric pressure by being a barometer, or even time by being a timepiece such as a wristwatch. It should be noted that such a measuring instrument can be a portable object.

With reference to FIG. 1, this system 1 comprises the display element 2 and in particular a mounting portion 6 of this element 2, as well as the drive shaft 3 and in particular an end piece 4a of this shaft 3. In this system 1, the end piece 4a and the portion 6 are configured to cooperate with each other in order to attach the display element 2 to the drive shaft 3. More specifically, the portion 6 comprises a pipe 14 in which a shaft hole 5 is provided, which hole is configured to mount the display element 2 on the drive shaft 3. In other words, this pipe 14 and the end piece 4a are configured to cooperate with each other to attach the display element 2 to the drive shaft 3.

Such a display element 2, also referred to as a “display indicator”, comprises a body 8 provided with a mounting portion 6 including an assembly area 7 comprising the pipe 14 in or with which the drive shaft 3 of a drive member of the display mechanism may be incorporated, integrated or associated. It should be noted that the invention is applicable to analogue display mechanisms for a mechanical, electronic or hybrid timepiece.

In the embodiment of the attachment system 1, this display element 2 is preferably a display hand 2. However, it is clearly understood that this display element 2 is obviously not limited solely to a hand 2 and that it can be completely different therefrom, and be for example, a disc. It should also be noted that this display element 2 is described here in the particular, but non-limiting, case of a rotating element such as a rotating hand 2. However, in principle, the invention is also applicable to a display element 2 with a non-circular trajectory of motion, for example a linear cursor, or the like.

It should also be noted that when the measuring instrument is a timepiece, this hand 2 can be included in the display mechanism as an hour, minute or seconds hand 2 with a variable length or variable radial extension.

With reference to FIG. 1, this display hand 2 comprises a body 8 formed by a plate 8 comprising a first end provided with a counterpoise 9 and a second opposite end including a tip 10 indicating information such as, for example, a time when the display mechanism is that of a timepiece. In this plate 8, such a tip 10 in this case takes the shape of a triangle, but could take any other suitable shape in order to indicate a specific angular position on a dial of the timepiece. The counterpoise 9 is preferably rectangular in shape. However, it can take any other shape, for example the counterpoise 9 could take the shape of a logo.

In this hand 2, the plate 8 also has a head located between the counterpoise 9 and the tip 10 of the hand 2. Such a head comprises the mounting portion 6 in which the drive shaft 3 can be incorporated or integrated in particular in the pipe 14 of the assembly area 7 of this portion 6. Such an assembly area 7 and thus the pipe 14 comprises a shaft hole 5 also referred to as the “adjustment diameter” which is provided for the incorporation of the embeddable end piece 4a of the drive shaft 3. It should be noted that this shaft hole 5 has a surface area substantially smaller than a cross-section of the embeddable end piece 4a. The term ‘substantially smaller’ is understood to mean “strictly smaller” or “essentially smaller”. This shaft hole 5 has two opposing openings 15a, 15b visible in FIG. 1.

In this context, the plate 8 is made in whole or in part from a material which has the property of softening, such as a plastic material, in particular a thermoplastic material. Preferably, such a material is a rigid material with the property of softening. Under these conditions, this material can be heated sufficiently to soften and become rigid/hard again when cooled. This plastic material is composed of straight or branched chain polymers which are able to deform and be shaped under the effect of heat. This plastic material comprises, for example, thermoplastic polymers.

It is thus understood that this plate 8 can be made solely or entirely of this material having this property of softening. Alternatively, such a plate 8 can be partly made of this material with at least the mounting portion 6 and thus the pipe 14 being made of this material.

In this system 1, the drive shaft 3 comprising an axis of revolution A1 is also referred to as the “rotary shaft” or “driving shaft”. Such a shaft 3 comprises the embeddable end piece 4a which is configured to be incorporated into, integrated into or associated with the pipe 14 of the assembly area 7 of this mounting portion 6 of the plate 8 of this hand 2. It should be noted that this end piece 4a is specifically configured to be attached or anchored in this area 7.

In FIGS. 1 and 3, the drive shaft 3 comprises a main part 4b which is connected to the drive member of the display mechanism and a free end which forms the embeddable end piece 4a, also referred to as the “pivot”, of this shaft 3. Such an end piece 4a is preferably formed integrally in one piece with the main part 4b of the shaft. Alternatively, this end piece 4a can be a part fastened to this main part 4b by being assembled to this part 4b in a non-limitative and non-exhaustive manner by driving, bonding or welding.

The shape of such an embeddable end piece 4a is substantially cylindrical. It is of course understood that it can take other shapes. Such an embeddable end piece 4a is preferably made of a material having a softening point that is higher than that of the material constituting the mounting portion 6 and therefore the pipe 14 where it is likely to be incorporated, integrated or associated. Such a material is preferably metallic, such as aluminium, brass, steel or titanium. Alternatively, this material can also be a thermosetting material. It should be noted that the main part 4b of the shaft is preferably also made of the same material as this end piece 4a. Alternatively, this main part 4b can be made of a different material to that of the end piece 4a, although such a material must have a softening point substantially similar to that of the material making up this embeddable end piece 4a.

Furthermore, in FIGS. 1 to 3, this end piece 4a comprises a part of the peripheral wall 13 of the shaft 3 which is provided with an outer surface for bonding with the pipe 14 of this mounting portion 6 of the plate 8, in particular a patterned outer bonding surface. Such a patterned outer surface comprises a plurality of raised patterns 12. This plurality of patterns 12 preferably extends over the entire outer surface of this part of the peripheral wall 13. Alternatively, this plurality of patterns 12 can be distributed over particular areas of this outer surface, which areas are configured to cooperate with the material constituting the pipe of this mounting portion 6 of the plate 8 of this hand 2. It should be noted that these patterns 12 can be identical, i.e. have a similar three-dimensional shape, as can be seen in FIG. 2. It should be noted that this three-dimensional shape is specifically configured to ensure robust mechanical anchoring of the end piece 4a in the pipe 14 of this assembly area 7 of the portion 6.

Such a patterned outer surface helps to increase the contact surface of this end piece 4a with the material used in the pipe of this mounting portion 6 of the plate 8. Moreover, in this configuration, the material can be inserted on and between the raised patterns 12 on this surface to ensure that the plate 8 is held securely on this end piece 4a. It is therefore understood that the hold of this end piece 4a in this pipe 14 of this portion 6 is then improved and thus helps to ensure the optimal mechanical anchoring thereof in this pipe 14.

As already mentioned, this end piece 4a of the shaft 3 is embedded by integration/association or melting in the pipe 14 of this mounting portion 6 of the plate 8. More specifically, this end piece 4a is embedded in this pipe 14 of this 6 as a portion result of an operation of melting/integrating/associating the materials constituting respectively the end piece 4a of the shaft 3 and the pipe 14 of this mounting portion 6. Such an operation softens the material making up the portion 6 comprising this pipe 14 by supplying energy to ensure that the end piece 4a is inserted and anchored into this mounting portion 6 and in particular into the pipe 14 of the assembly area 7. Thus, in this assembly area 7 of the mounting portion 6 with said end piece 4a, the materials constituting said end piece 4a and said portion 6 comprising the pipe 14, respectively, are incorporated into each other by melting, integration or association thanks to this supply of energy. It should be noted that this energy can be supplied, in a non-limiting and non-exhaustive manner, by ultrasound or by a heating element, by a laser or by a steam jet.

In the case of using ultrasound, such an operation can be an ultrasonic melting/integration/association operation. This operation softens the material constituting the portion 6 comprising the pipe 14 by applying mechanical vibrations to said portion 6, said mechanical vibrations resulting from ultrasound. In this context, these mechanical vibrations will then generate frictional heat in the portion 6 of material with the property of softening, and excite its molecules, which will in turn start to move. Thus, the material of this portion 6 comprising the pipe 14 becomes more flexible as it softens, allowing the end piece 4a to be inserted/embedded in this portion 6 and to bond to this material. In particular, this end piece 4a is then embedded in the shaft hole 5 of the assembly area 7. In this context, the assembly area 7 clamps this end piece 4a in the pipe 14 of this mounting portion 6 and thus helps to hold the hand 2 axially and rotatably on the drive shaft 3.

In this configuration, where the end piece 4a is arranged in the plate 8 of the hand 2, it should be noted that the peripheral wall 13 comprising the end piece 4a projects on either side of the opposite faces of the portion 6 of said plate 8 of the display hand 2. These two opposite faces are joined together by a side wall of this hand 2. Such an arrangement of the end piece 4a in this portion 6 helps to stabilise the display hand 2 axially and rotatably.

More specifically, said end piece 4a comprises first and second parts 16a, 16b which project respectively from the two opposite openings 15a, 15b of the shaft hole 5 of the pipe 14. These first and second parts 16a, 16b delimit the surface of the end piece 4a on the peripheral wall 13 of the drive shaft 3. In this configuration, these first and second parts 16a, 16b of the end piece 4a have thicknesses E3, E4 which are preferably similar. Such thicknesses E3, E4 are less than the thickness:
E1 of the end piece 4a;
E2 of the pipe 14.

Such an arrangement of the end piece 4a in this pipe 14 helps to stabilise the display hand 1 axially and rotatably. Moreover, this arrangement helps to even out the distribution of stresses to which the hand 2 may be subjected when it is assembled on the drive shaft as well as after it has been assembled on this shaft. In other words, such stresses are distributed uniformly over the entire thickness E2 of the body 8. This uniform distribution ensures that the body 8 of the hand 2 and of the portion 6 comprising the pipe 14 remain flat. Thus, the body 8 of the hand 2 remains flat after assembly on the shaft 3.

It is understood that such an arrangement of the end piece 4a in the body 8 of the hand 2 allows a wider range of materials to be used, in particular by making it less necessary to use materials that are expressly reinforced to prevent deformation of the hand that can result from such stresses.

It should also be noted that the display hand 2 is symmetrical relative to a longitudinal plane of symmetry P1 and/or a transverse plane of symmetry P2 of this hand 2. It is understood that these two planes P1, P2 are perpendicular to each other. By being symmetrical, such a display hand 2 is reversible, which helps to simplify and reduce the time taken to assemble it in a display mechanism. In other words, such a display hand 2 can be assembled on the shaft 3 with a visible face which can be either of its two opposite faces.

The above description corresponds to a preferred embodiment and can under no circumstances be considered to be limiting, and more particularly as regards the type of display element 2 used in this system 1. More specifically, other display elements such as discs, in particular date discs, are also part of the invention.

Moreover, this description is also not limited to the form described for the various structural elements making up the display element 2 or their materials. A person skilled in the art will not have any particular difficulty in choosing, for example for the plate 8 of the hand 2, any other material with the mechanical properties necessary for the implementation of the present invention.

The possible applications for this system 1 for attaching the display element 2 are very numerous, since the present invention can be implemented in any type of object or device, particularly a portable object or device, comprising a display element 2.

### NOMENCLATURE

1. System for attaching a display element
2. Display element
3. Drive shaft
4a. Embeddable end piece of the drive shaft
4b. Main part of the drive shaft
5. Shaft hole of the display element
6. Mounting portion of the display element
7. Assembly area of the display element
8. Body of the display element or plate of the hand
9. Counterpoise of the plate
10. Tip of the plate
12. Plurality of patterns
13. Peripheral wall of the drive shaft
14. Pipe of the display component
15a, 15b. First and second openings of the shaft hole
16a, 16b. First and second parts projecting from the shaft hole
A1. Axis of revolution of the drive shaft
P1. Longitudinal plane of symmetry P1 of the display element/hand
P2. Transverse plane of symmetry P2 of the display element/hand

1. A system (1) for attaching a display element (2) to a drive shaft (3) fitted to an analogue display mechanism of a measuring instrument, the system (1) comprising a portion (6) for mounting the display element (2) made of a material that has the property of softening and an embeddable end piece (4a) of said drive shaft (3) configured to be incorporated into said portion (4a) by melting, said end piece (4a) comprising part of a peripheral wall (13) of the drive shaft (3) provided with a patterned outer bonding surface configured to mechanically anchor said end piece (4a) in said portion (6).

2. The system (1) according to claim 1, wherein the mounting portion (6) comprises a pipe (14) in which a shaft hole (5) is made and configured to mount the display element (2) to the drive shaft (3).

3. The system (1) according to claim 1, wherein the embeddable end piece (4a) is incorporated into the pipe (4) by melting.

4. The system (1) according to claim 1, wherein said patterned outer surface comprises a plurality of raised patterns (12).

5. The system (1) according to claim 1, wherein aid patterned outer surface comprises a plurality of raised patterns (12) extending over all or part of the patterned outer surface.

6. The system (1) according to claim 1, wherein the part of the peripheral wall (13) of said end piece (4a) projects on either side respectively of the opposite faces of the mounting portion (6) of said display element (2).

7. The system (1) according to claim 1, wherein said end piece (4a) comprises first and second parts (16a, 16b) projecting respectively from the two opposite openings (15a, 15b) of the shaft hole (5) of the pipe (14).

8. The system (1) according to claim 1, wherein the material liable to soften comprises, in whole or in part, a plastic material having the property of softening.

9. The system (1) according to claim 1, wherein said embeddable end piece (4a) is made of a material having a softening point that is higher than a softening point of the material constituting said mounting portion (6).

10. The system (1) according to claim 1, further comprising an area (7) for assembling the mounting portion (6) with said end piece (4a), wherein the materials respectively constituting said end piece (4a) and said pipe (14) are incorporated into one another by melting, integration or association, in particular by melting, integration or association using ultrasound.

11. The system (1) according to claim 1, wherein said display element (2) has a body (8) that is symmetrical relative to a longitudinal plane of symmetry (P1) and/or a transverse plane of symmetry (P2).

12. The system (1) according to claim 1, wherein said display element (2) is a display hand (2) whose body (8) comprises a plate (8) provided with the assembly area (7).

13. A measuring instrument comprising at least one display element (2) mounted on an embeddable end piece (4a) of a drive shaft (3) using the attachment system (1) according to claim 1.

14. An instrument according to claim 1, which instrument is a timepiece.
